(19) United States
(12) Patent Application Publication
(10) Pub. No.: US 2011/0314373 A1
(43) Pub. Date: Dec. 22, 2011

(54) SYSTEM, METHOD AND COMPUTER PROGRAM PRODUCT FOR PERFORMING ACTIONS ASSOCIATED WITH DATA TO BE DISPLAYED, UTILIZING A WIDGET

(75) Inventors: Didier Prophete, San Francisco, CA (US); Mark Movida, Berkeley, CA (US); Ronald Fischer, San Francisco, CA (US); Krystof Oblucki, Oakland, CA (US)

(73) Assignee: SALESFORCE.COM, INC., San Francisco, CA (US)

(21) Appl. No.: 13/018,316

(22) Filed: Jan. 31, 2011

Related U.S. Application Data
(60) Provisional application No. 61/357,070, filed on Jun. 21, 2010.

(51) Int. Cl. G06F 17/00

(52) U.S. Cl. 715/273

(57) ABSTRACT

In accordance with embodiments, there are provided mechanisms and methods for performing actions associated with data to be displayed, utilizing a widget. These mechanisms and methods for performing actions associated with data to be displayed, utilizing a widget can enable enhanced and expedited data development, improved data display, etc.

### CLAIM OF PRIORITY

This application claims the benefit of U.S. Provisional Patent Application 61/357,070, entitled “Methods and Systems for using smart widgets in a multi-tenant database environment,” by Prophete et al., filed Jun. 21, 2010 (Attorney Docket No. SEC1P144+/424PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to displaying content, and more particularly to displayed content utilizing a widget.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventional systems commonly allow for development of content associated with data found within the systems. For example, a system may allow a developer to create an application, web content, etc. that includes records found within the system. Unfortunately, techniques for supporting an appropriate display of such content have been associated with various limitations.

Just by way of example, traditional methods of developing web pages that include system data may necessitate that the developer manually control elements associated with the display of the system data in accordance with requirements from the system. For instance, in order to comply with requirements instated by the system, the developer may have to manually format the data, manually validate the data, manually adjust the display of data, etc. Accordingly, it is desirable to provide techniques that improve the performance of actions associated with system data to be displayed.

### BRIEF SUMMARY

In accordance with embodiments, there are provided mechanisms and methods for performing actions associated with data to be displayed, utilizing a widget. These mechanisms and methods for performing actions associated with data to be displayed, utilizing a widget can enable enhanced and expedited data development, improved data display, etc.

In an embodiment and by way of example, a method for performing actions associated with data to be displayed, utilizing a widget is provided. In one embodiment, data to be displayed is identified. Additionally, the data to be displayed is associated with a widget. Additionally, one or more actions associated with the data to be displayed are performed, utilizing the widget.

While one or more implementations and techniques are described with reference to an embodiment in which performing actions associated with data to be displayed, utilizing a widget is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for performing actions associated with data to be displayed, utilizing a widget, in accordance with one embodiment;

FIG. 2 illustrates a method for rendering and displaying an element utilizing a widget and metadata associated with the element, in accordance with another embodiment;

FIG. 3 illustrates an exemplary display of an entire record utilizing a high-level widget, in accordance with another embodiment;

FIG. 4 illustrates an exemplary component lifecycle of a field displayed by a widget, in accordance with another embodiment;

FIG. 5 illustrates a block diagram of an example of an environment wherein an on-demand database system might be used; and

FIG. 6 illustrates a block diagram of an embodiment of elements of FIG. 4 and various possible interconnections between these elements.

### DETAILED DESCRIPTION

### General Overview

Systems and methods are pr vided for performing actions associated with data to be displayed, utilizing a widget.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for performing actions associated with data to be displayed, utilizing a widget will be described with reference to example embodiments.

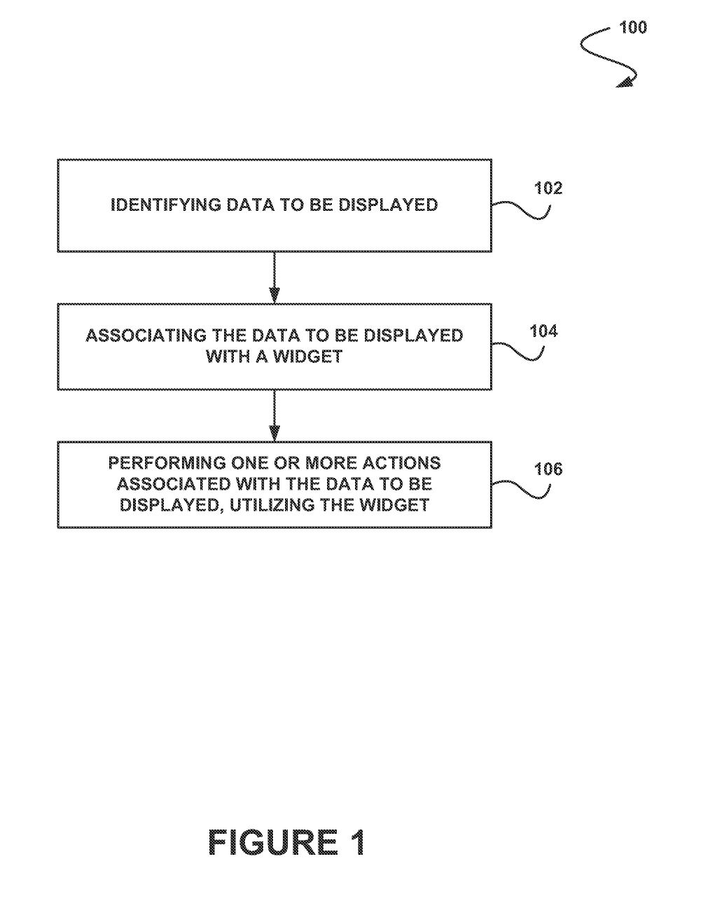

FIG. 1 illustrates a method 100 for performing actions associated with data to be displayed, utilizing a widget, in accordance with one embodiment. As shown in operation 102, data to be displayed is identified. In one embodiment, the data may include data that is stored in a system (e.g., a server, a client, a multi-tenant on-demand database system, etc.). For example, the data may include data retrieved from a multi-tenant on-demand database system and stored in a local store of a client. In yet another embodiment, the data may be stored in a data structure (e.g., a database, etc.). In another embodiment, the data may be associated with an entity. For example, the data may be associated with a customer of the system.

Also, in another embodiment, the identified data may include data that is desired to be displayed to a user. For example, the data may include data that is to be displayed on a web page, as part of an application, on a display screen, etc. Of course, however, the identified data may be desired to be displayed in any manner.

Additionally, as shown in operation 104, the data to be displayed is associated with a widget. In one embodiment, an identifier of the data may be associated with the widget. For example, the identifier may include any representation of the data to be displayed (e.g., alphanumeric text, a symbol, etc.). In another example, the identifier may include an object. In another example, the identifier may include a field of the object.

Further, in still another embodiment, the widget may include a software application. For example, the widget may include an application that assists with the display of the data. Also, in one embodiment, the data may be associated with the widget by calling the widget in association with the data. For example, the data may be included as a parameter of a call to the widget. In another embodiment, the data may be associated with the widget by a developer. For example, a developer of an application including the data to be displayed may associate the data with the widget during code development (e.g., before rendering the web page code, etc.).

Additionally, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Furthermore, as shown in operation 106, one or more actions associated with the data to be displayed are performed, utilizing the widget. In one embodiment, the one or more actions may include accessing metadata associated with the data to be displayed. For example, the widget may retrieve metadata describing one or more of a format of the data to be displayed, metadata describing additional data associated with the data to be displayed, metadata describing a format of a layout associated with the display of the data (e.g., positioning, etc.), metadata associated with grouping, metadata associated with validation, etc. In another embodiment, the widget may retrieve the metadata from the source of the data to be displayed. For example, the widget may retrieve the metadata from the multi-tenant on-demand database system. In another embodiment, the metadata may describe a particular layout of the data to be displayed (e.g., a preferred layout, a layout used by the system, etc.).

Also, in one embodiment, the one or more actions may include performing validation based on metadata associated with the data to be displayed. For example, the widget may retrieve metadata from a system and may determine whether the metadata retrieved from the system is different from metadata stored locally. In another example, the widget may use the metadata in order to validate one or more parameters of the widget (e.g., the valid range of the widget, the display of the widget, any aggregation performed by the widget, etc.). In another embodiment, the one or more actions may include determining a required implementation for the data to be displayed. For example, the widget may determine whether the data is required to be implemented in a particular fashion. In yet another embodiment, the required implementation for the data to be displayed may be dictated by metadata from the source of the data, (e.g., a system, etc.).

Additionally, in one embodiment, the one or more actions may include retrieving the data to be displayed. For example, the widget may retrieve the data to be displayed from the system where it is stored. In another embodiment, the one or more actions may include rendering and displaying the data. For example, the widget may render and display the data as part of a web page, presentation, mobile display, application, etc.

Further, in still another embodiment, the one or more actions may include formatting the data to be displayed. For example, the data may include a monetary amount, and the widget may format the data to conform to a standard in which such a monetary amount is displayed. In another example, the data may include a text box, and the widget may format the size and shape of the text box. In another embodiment, the format of the data to be displayed may be dictated by metadata from the source of the data, a system, etc.

Also, in one embodiment, the one or more actions may include displaying a label of the data in addition to the data to be displayed. For example, the identifier of the data may include a label of the data, and the widget may display the label along with the data. Further, in yet another embodiment, one or more modes associated with the data to be displayed may be supported by the widget. For example, if metadata associated with the data to be displayed indicates that the data is to be displayed as read only, the widget may display the data as read only. In another example, if metadata associated with the data to be displayed indicates that the data is to be presented in a particular mode (display, create, edit, etc.), the widget may present the data as such.

Further still, in another embodiment, the one or more actions associated with the data to be displayed may be performed by the widget during rendering of code associated with the display of the data. For example, a developer may draft the code associated with the display of the data, and the one or more actions may be performed by the widget when such code is rendered. In yet another embodiment, a plurality of widgets may be utilized to display the data. For example, the data may include a plurality of fields within an object, and each field may be displayed utilizing a widget. In still another embodiment, a high level widget may control the plurality of widgets (e.g., control the layout of the plurality of widgets, manage the plurality of widgets, etc.).

In this way, the widget may automatically handle metadata associated with the data to be displayed. Additionally, the widget may handle the metadata when the widget is started, when the widget synchronizes with the system, etc. Further, the widget may enable a developer to comply with metadata associated with the display of data without having to manually access and interpret the metadata. Also, the widget may allow for a detailed display of the data, including active hyperlinks, clickable fields, field alerts, etc., thereby allowing developers to be consistent with suggested system web applications when creating applications, and allowing developers to avoid any errors caused by inconsistencies between the system and the software being developed.

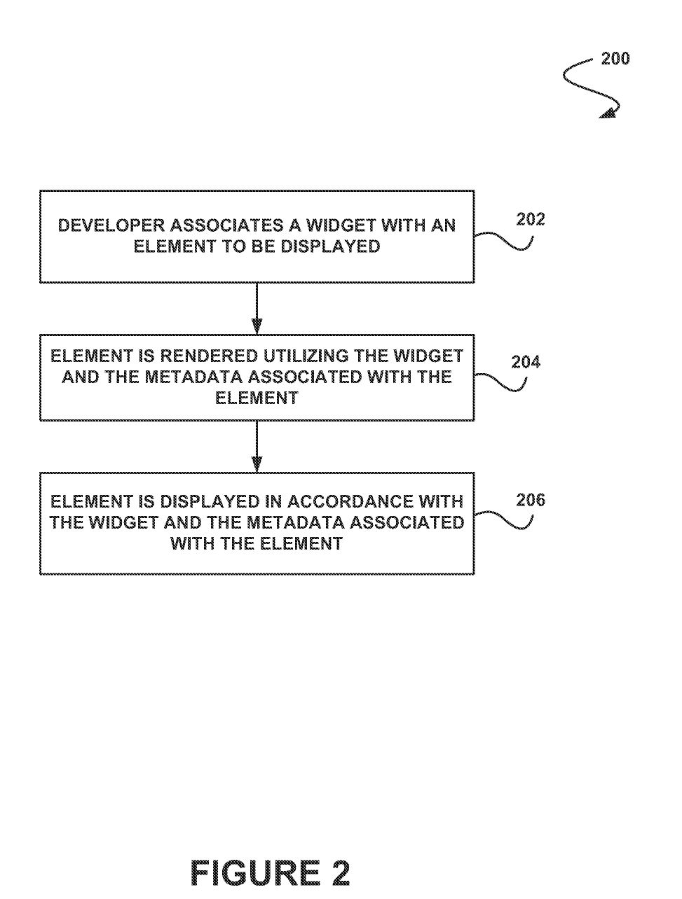

FIG. 2 illustrates a method 200 for rendering and displaying an element utilizing a widget and metadata associated with the element, in accordance with another embodiment. As an option, the present method 200 may be carried Gut in the context of the functionality of FIG. 1. Of course, however, the method 200 may be carried out in any desired environment. The aforementioned definitions may apply during the present description.

As shown in operation 202, a developer associates a widget with an element to be displayed. In one embodiment, the element may include an element of an account of a system, where the account is associated with the developer. In another embodiment, the widget may include a FieldElement widget. For example, the element may include a field in the system (e.g., a value field, a picklist, etc.), and the FieldElement widget may display a value of the field. In another embodiment, the widget may include a LabelAndField widget. For example, the element may include a field in the system as well as a label for the field, and the LabelAndField widget may display the label in association with the value of the field (e.g., on the left of the field value, in a manner similar to how the label and value are displayed on a detail/edit page of the system, etc.)

Additionally, in another embodiment, the widget may include a FieldContainer widget. For example, the widget may include and manage a plurality of FieldElement widgets and/or LabelAndField widgets. Further, in yet another embodiment, the widget may include an EntityContainer widget. For example, the widget may display an entire record of the system, and may manage one or more additional widgets as well as a layout of those widgets.

Additionally, in another embodiment, the widget may be associated with the element utilizing code. For example, in order to include a FieldElement widget in a user interface (UI) created by a developer, the developer may use the following code: ‘<stratus:FieldElement id=“fieldElement” field=“AccountWebsite”/>’, where “Account.Website” is the field name associated with the FieldElement widget. In another example, in order to include a LabelAndField widget in a user interface created by a developer, the developer may use the following code: ‘<stratus:LabelAndField field=“Account.Website”/>’, where “Account.Website” is the field name associated with the LabelAndField widget.

Further, Table 1 illustrates exemplary code for including a FieldContainer in a UI created by a developer. Of course, it should be noted that the code shown in Table 1 is set forth for illustrative purposes only, and thus should not be construed as limiting in any manner.

TABLE 1
<stratus:FieldContainer id=“_editFieldContainer” width=“100%”>

<stratus:LabelandField field=“Account.Name” />
<!-- This is a virtual field that expands to include all of the sub-fields
in a Billing Address -->
<stratus:LabelandField field=“Account.BillingStreet[Group]” />
<stratus:LabelandField field=“Account.ParentId” />
<stratus:LabelandField field=“Account.Type” />
<stratus:LabelandField field=“Account.Website” />
<stratus:LabelandField field=“Account.CreatedDate” />
<stratus:LabelandField field=“Account.AnnualRevenue” />

</stratus:FieldContainer>

Additionally, it should be noted that in Table 1, “[Group]” represents a group widget. In one embodiment, a group widget may include a grouping of a plurality of metadata (e.g., a street name, a street number, a city, a state, etc.). For example, the group widget may represent a group stored in the system. Also, in another embodiment, the code may include Adobe ActionScript, Hex, Air, etc. Additionally, in vet another embodiment, in order to include a EntityContainer widget in a user interface (UI) created by a developer, the developer may use the following code: ‘<stratus:EntityContainer id=“_editFieldContainer” width=“100%”/>’.

Further, as shown in operation 204, the element is rendered utilizing the widget and the metadata associated with the element. In one embodiment, the element may be rendered utilizing code drafted by the developer. For example, the developer may draft the following code, which may display the value of the field Website of the account object, provided “account” is an instance of “Account”:“_fieldElement.render(account);”. In another embodiment, the widget may include a smart widget. For example, the FieldElement widget may be a smart widget in that it may know how to render any field in the system, as long as the developer passes a fully qualified field name (e.g. Account.Website, Opportunity.Status, etc.). This may simplify the developer's task in that the developer may only need to put Field widgets on the screen, initialized with the proper field name and simply bind them to system objects to trigger the rendering.

Further still, in yet another embodiment, if the widget includes a FieldContainer widget, the programmer may call render on the FieldContainer instead of having to manage each and every LabelAndField and/or FieldElement within the FieldContainer widget.

Additionally, as shown in operation 206, the element is displayed in accordance with the widget and the metadata associated with the element. In one embodiment, the widget may account for one or more display details associated with the element (e.g., details saved in the metadata, etc.). For example, the FieldElement widget may know from accessing metadata on the server associated with the “Website” field that “AccountoWebsite” needs to be rendered as a URL field (and is not just a simple text field). In another example, after calling a render method on the LabelandField widget, where the element to be displayed has an associated label, the label may be displayed as well as the value of the element. For instance, if the element to be displayed is a URL of “http://www.12345asdf.net,” and the label associated with the element is “Website,” then after the element is rendered, both the label and the URL may be displayed, where the URL is rendered as a hyperlink: “Website http://www.12345asdf.net”.

In yet another example, the FieldContainer widget may group together (e.g., aggregate, etc.) LabelAndField and/or FieldElement widgets to show multiple data elements associated with the same object (e.g., the same Opportunity object, etc.). Table 2 illustrates an exemplary display that results after rendering the code in Table 1. Of course, it should be noted that the display shown in Table 2 is set forth for illustrative purposes only, and thus should not be construed as limiting in any manner.

TABLE 2

| Account Name: | James 2 |
|---|---|
| Billing Address: | 123 Street_Name St. |
| | City_Name, State_Name Zip_Code |
| Parent Account: | testRayX2 |
| Type: | Competitor |
| Website: | http://www.12345asdf.net |
| Created Date: | Feb. 12, 2010 10:35 AM |
| Annual Revenue: | $10000000 |

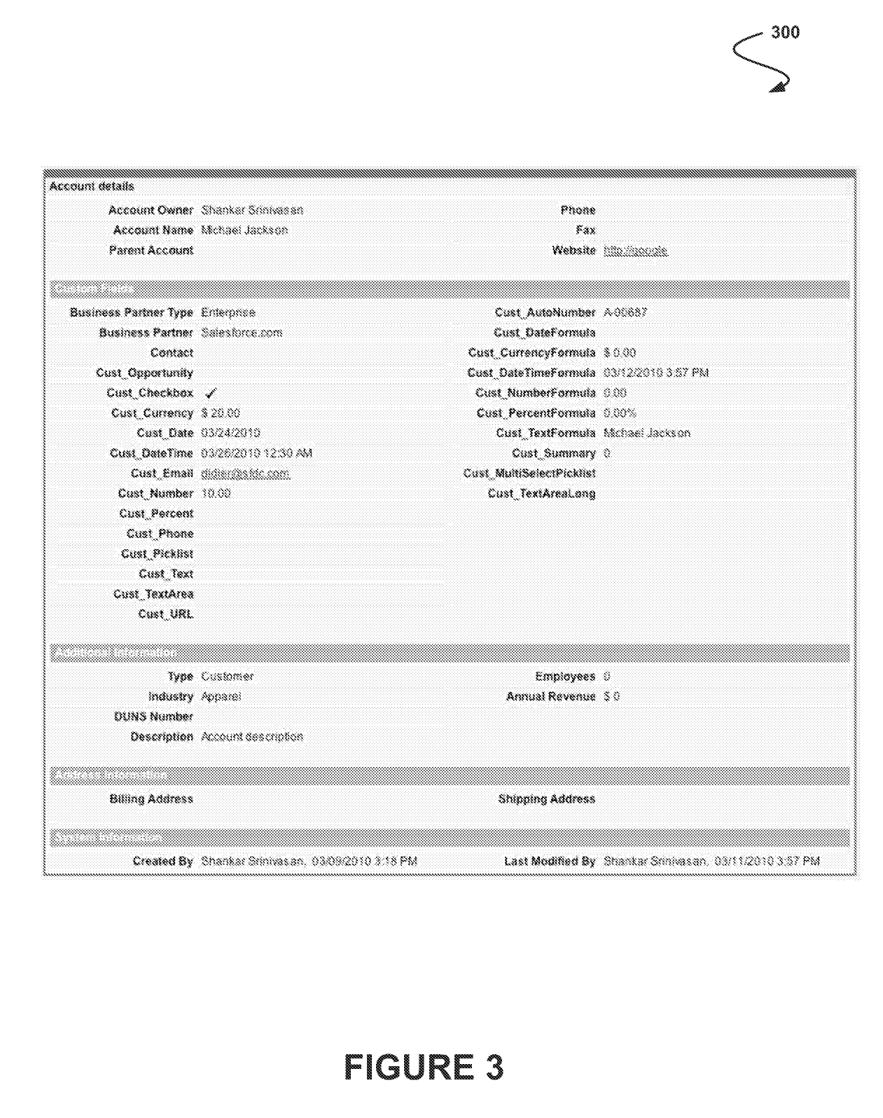

Additionally, in one embodiment, the widget may format one or more aspects of the display of the element. For example, an EntityContainer widget may use layout metadata information retrieved from the system to position one or more fields within the elements being displayed. For instance, FIG. 3 illustrates an exemplary display 300 of an entire record utilizing a high-level widget (e.g., an EntityContainer widget, etc.), in accordance with another embodiment. In this way, metadata associated with the record may be used in order to replicate an environment dictated by the metadata as closely as possible. In another embodiment, the developer may not need to specify a type of the element being rendered (e.g., the code may not specify that it is being used to render a particular object). In this way, metadata may be leveraged to construct user interfaces using a markup language (e.g., DHTML, etc.). For example, the metadata may be repurposed to create one or more widgets useful for element display development.

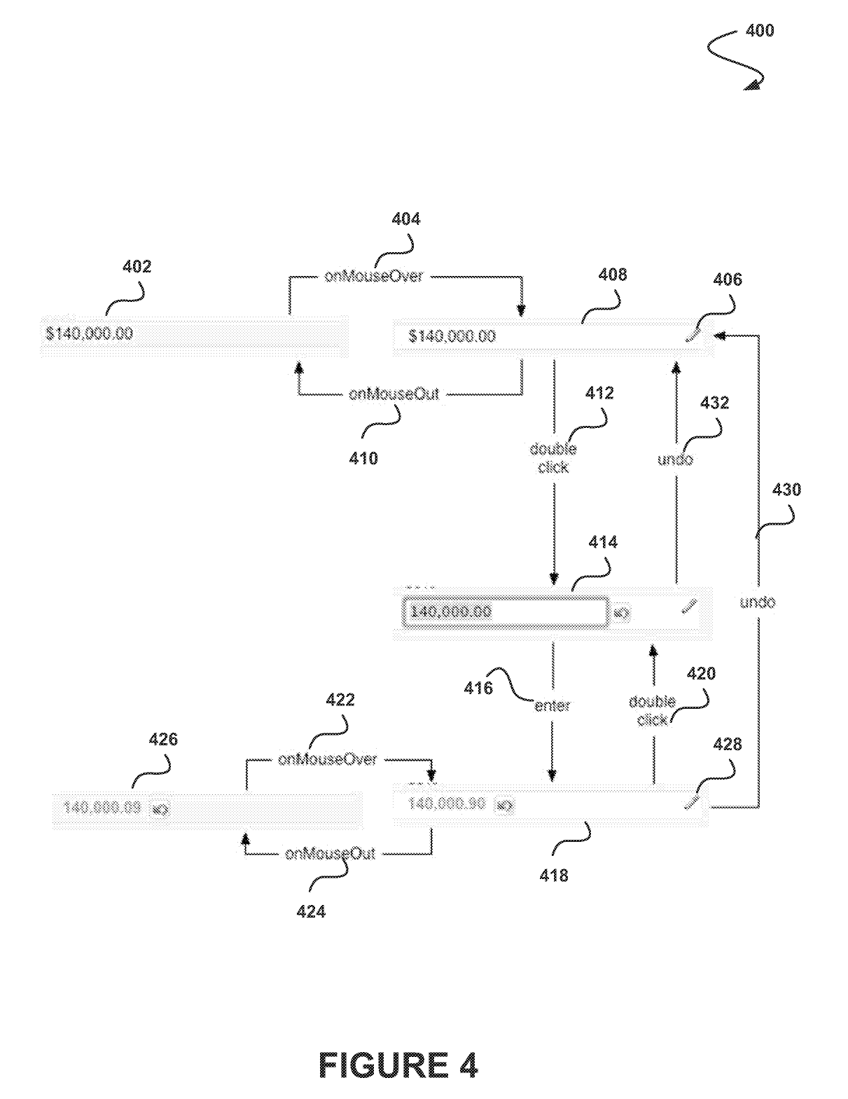

FIG. 4 illustrates an exemplary component lifecycle 400 of a field displayed by a widget, in accordance with another embodiment. As an option, the present lifecycle 400 may be carried out in the context of the functionality of FIGS. 1-3. Of course, however, the lifecycle 400 may be carried out in any desired environment. The aforementioned definitions may apply during the present description.

As shown, the component lifecycle 400 may include a full inline-edit component lifecycle. More specifically, as shown in operation 404, upon mousing over the field 402, an icon 406 appears, indicating the allowance of editing of the field 408. Additionally, as shown in operation 410, upon mousing out of the field 408, the field returns to its prior state 402. Further, as shown in operation 412, upon double clicking the field 408, the text within that field is highlighted in the field 414. Further still, as shown in operation 416, upon selecting an enter command in association with the field 414, the data within the field 414 is saved in the field 418.

Also, as shown in operation 420, upon double clicking the field 418, the text is again highlighted in the field 414. In addition, as shown in operation 424, upon mousing out of the field 418, the field returns to a non-editable state 426. Further, as shown in operation 422, upon mousing over the field 426, an icon 428 appears, indicating the allowance of editing of the field 418. Further still, as shown in operation 430, selecting an undo command when the field 418 is shown will return to the field 408. Likewise, as shown in operation 432, selecting an undo command when the field 414 is shown will return to the field 408.

In one embodiment, the full inline-edit component lifecycle 400 may be associated with a field to be displayed that is stored at a system, and such lifecycle may be dictated by metadata stored in a system in association with the field, which may be implemented by a widget. For example, the widget may include a FieldElement widget, and the FieldElement widget may act as a container which may implement the behavior of a full inline-edit lifecycle (e.g., showing a pencil icon, monitoring on MouseOver/Out events, showing the undo icon after being changed, etc.). In another embodiment, displaying the real value of the field may be delegated to a FieldComponent which may be injected into the FieldElement. In yet another embodiment, the FieldElement may inspect the fully qualified field name to decide which FieldComponent to use at runtime. For example, the following field components may be available for each field type in a system: CheckboxComponent, CurrencyComponent, NumberComponent, PercentComponent, Grouped, Text Area, DateTime, etc.

### System Overview

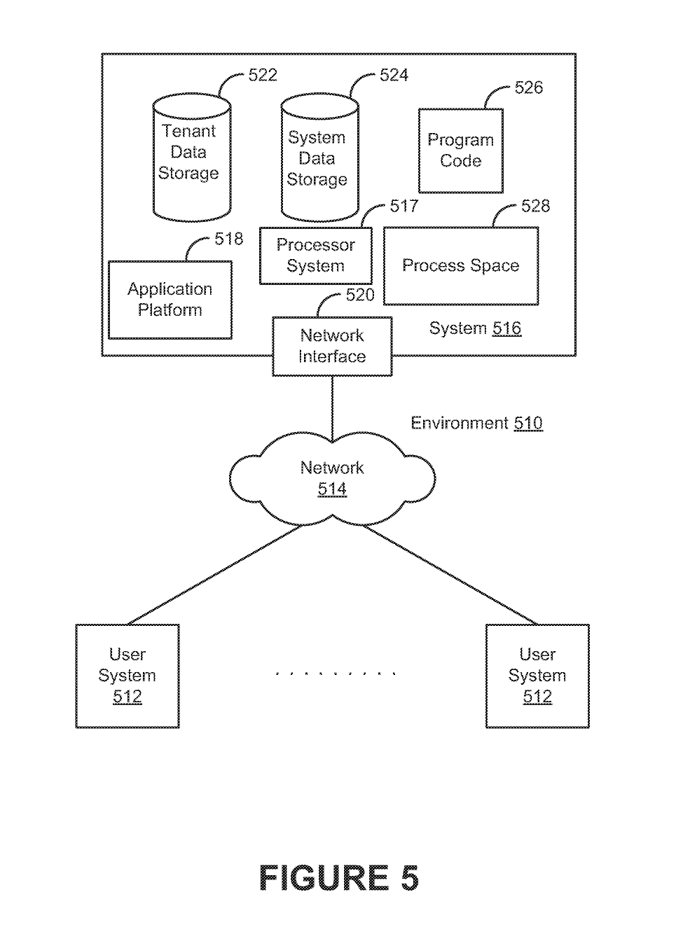

FIG. 5 illustrates a block diagram of an environment 510 wherein an on-demand database system might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

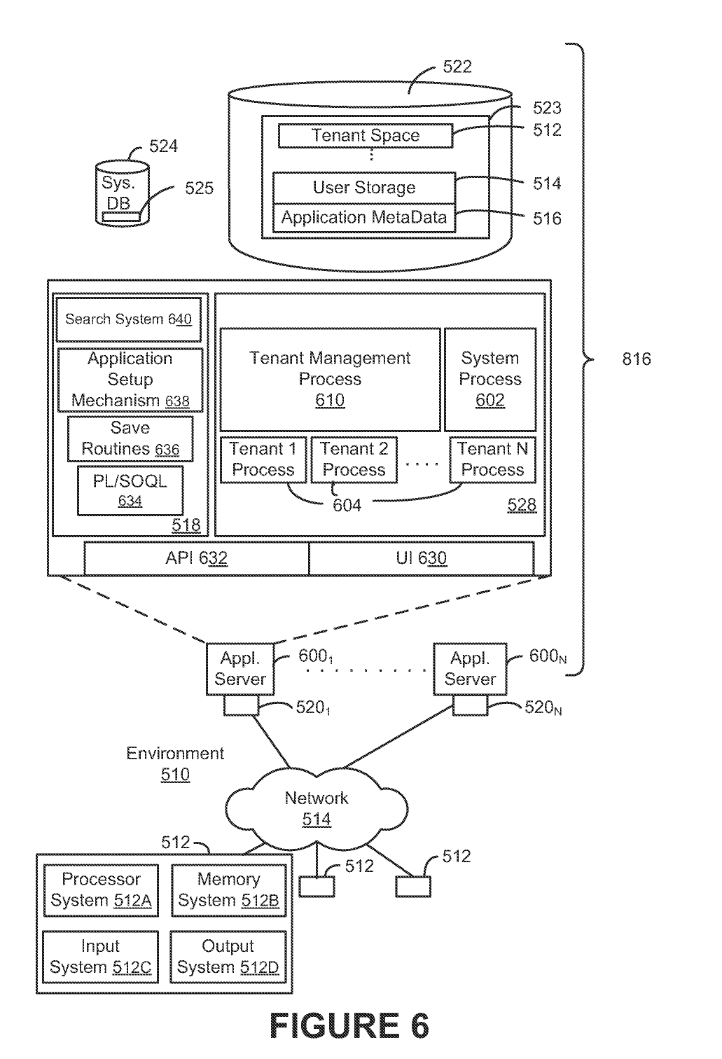

Environment 510 is an environment in which an on-demand database system exists. User system 512 may be any machine or system that is used by a user to access a database user system. For example, any of user systems 512 can be a handheld computing device, a mobile phone, a laptop computer, a work station, and/or a network of computing devices. As illustrated in FIG. 5 (and in more detail in FIG. 6) user systems 512 might interact via a network 514 with an on-demand database system, which is system 516.

An on-demand database system, such as system 516, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database system 516 may include an application platform 518 that enables creation, managing and executing one or more applications developed by the provider of the on-demand database system, users accessing the on-demand database system via user systems 512, or third party application developers accessing the on-demand database system via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “L” that network will be used in many of the examples herein. However, it should be understood that the networks that the one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin MLR request distributors to balance loads and distribute incoming HTTP requests evenly over a plurality of servers. At least as for the users that are accessing that server, each of the plurality of servers has access to the MTS' data however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application(s) including computer code to run using a central processing unit such as processor system 517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to acid and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the use level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524, System 516 (e.g., an application server 600 in system 516) automatically generates one or more SQL statements (e.g., one or more SQL queries) that are designed to access the desired information, System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method for performing actions associated with data to be displayed, utilizing a widget, the method comprising:
identifying the data to be displayed;
associating the data to be displayed with the widget; and
performing one or more actions associated with the data to be displayed are performed, utilizing the widget.

2. The computer program product of claim 1, wherein the data includes data that is stored in a multi-tenant on-demand database system.

3. The computer program product of claim 1, wherein the identified data includes data that is desired to be displayed to a user.

4. The computer program product of claim 1, wherein the widget includes an application that assists with the display of the data.

5. The computer program product of claim 1, wherein the computer program product is operable such that the data is included as a parameter of a call to the widget.

6. The computer program product of claim 1, wherein the computer program product is operable such that a developer of an application including the data to be displayed associates the data with the widget during code development.

7. The computer program product of claim 1, wherein the one or more actions include accessing metadata associated with the data to be displayed.

8. The computer program product of claim 7, wherein the computer program product is operable such that the widget retrieves metadata describing one or more of a format of the data to be displayed, metadata describing additional data associated with the data to be displayed, metadata describing a format of a layout associated with the display of the data, metadata associated with grouping, and metadata associated with validation.

9. The computer program product of claim 7, wherein the computer program product is operable such that the widget may retrieve the metadata from the source of the data to be displayed.

10. The computer program product of claim 1, wherein the one or more actions include retrieving the data to be displayed.

11. The computer program product of claim 1, wherein the one or more actions include rendering and displaying the data.

12. The computer program product of claim 1, wherein the one or more actions include formatting the data to be displayed.

13. The computer program product of claim 12, wherein the format of the data to be displayed is dictated by metadata from a source of the data.

14. The computer program product of claim 1, wherein the one or more actions include displaying a label of the data in addition to the data to be displayed.

15. The computer program product of claim 1, wherein the computer program product is operable such that one or more modes associated with the data to be displayed are supported by the widget.

16. The computer program product of claim 1, wherein the computer program product is operable such that the one or more actions associated with the data to be displayed are performed by the widget during rendering of code associated with the display of the data.

17. The computer program product of claim 1, wherein the computer program product is operable such that a plurality of widgets is utilized to display the data.

18. The computer program product of claim 17, wherein the computer program product is operable such that the data includes a plurality of fields within an object, and each field is displayed utilizing a widget.

19. A method, comprising:
identifying data to be displayed;
associating the data to be displayed with a widget, utilizing a processor; and
performing one or more actions associated with the data to be displayed are performed, utilizing the widget.

20. An apparatus, comprising:
a processor for:
identifying data to be displayed;
associating the data to be displayed with a widget; and
performing one or more actions associated with the data to be displayed are performed, utilizing the widget.

21. A method for transmitting code for use in a multi-tenant database system on a transmission medium, the method comprising:
transmitting code for identifying data to be displayed;
transmitting code for associating the data to be displayed with a widget, utilizing a processor; and
transmitting code for performing one or more actions associated with the data to be displayed are performed, utilizing the widget.
